(19) United States
(12) Patent Application Publication
(10) Pub. No.: US 2003/0145085 A1
(43) Pub. Date: Jul. 31, 2003

(54) Table arrangement of sorted EPG data to facilitate searching on low resource clients

(76) Inventors: James Armand Baldwin, Redwood City, CA (US); Peter T. Barrett, San Francisco, CA (US)

Correspondence Address: LEE & HAYES PLLC, 421 W RIVERSIDE AVENUE SUITE 500, SPOKANE, WA, 99201

(21) Appl. No.: 10/061,813

(22) Filed: Jan. 31, 2002

(51) Int. Cl. G06F 15/173

(52) U.S. Cl. 709/225

(57) ABSTRACT

Program data for use in electronic program guides is sorted in advance of delivery to a low resource client. In the described implementation, the program data is sorted according to a parameter that is likely to be searched at the client, such as by program title, actor name, and so forth. In one example, the program data is sorted according to a stopped name version of the program title. When delivered to the client, the low resource client is able to perform fast binary searches on the sorted program data.

### TECHNICAL FIELD

This invention relates to television entertainment architectures in which program data is generated, processed, and distributed to low resource clients, such as set top boxes. More particularly, this invention relates to structuring the program data in advance of delivery to the client so that the program data may be more easily searched at the client.

### BACKGROUND

Electronic program guides (EPGs) enable TV viewers to navigate through an onscreen program guide and locate shows. With the guides, viewers can look at schedules of current and future programming, set reminders for upcoming programs, or enter instructions to record one or more shows.

Program data for an EPG is stored in the client memory. The amount of EPG data available for the EPG is dependent upon the resource environment at the client. In a low-resource environment, meaning the client has limited memory and/or processing resources, the amount of memory reserved for program data and the ability to perform operations on the data, such as searching, are limited.

In some systems, EPG data is broadcast as part of a national feed. The EPG data is indexed by channel to allow individual networks to obtain the appropriate EPG data for their clients. However, this limits the ability of a client to search on the data. For example, to search by title, the client can either sort the existing EPG data, which is resource expensive, or perform a lengthy search on unsorted data, which will be slow.

Accordingly, for such low-resource environments, there is a need to improve the structure of EPG data so that it can be more readily searched at the client.

### SUMMARY

Program data for use in electronic program guides is sorted in advance of delivery to a low resource client. In the described implementation, the program data is sorted according to a parameter that is likely to be searched at the client, such as by program title, actor name, and so forth. In one example, the program data is sorted according to a stopped name version of the program title. When delivered to the client, the low resource client is able to perform fast binary searches on the sorted program data.

### BRIEF DESCRIPTION OF THE DRAWINGS

FIG. 1 illustrates a television entertainment system including a publisher to generate program data, a data center to process the program data, and one or more head ends to distribute the program data to multiple clients.

FIG. 2 is a block diagram of a server computer resident at the data center to process the program data.

FIG. 3 is a block diagram of an exemplary client implemented as a set top box.

FIG. 4 is a diagrammatic illustration of tables used to organize program data.

FIG. 5 illustrates an exemplary sorting process in which the program data is sorted prior to delivery to the clients.

### DETAILED DESCRIPTION

The following discussion is directed to television entertainment systems, such as interactive TV networks, cable networks that utilize electronic program guides, and Web-enabled TV networks. Clients in such systems range from full-resource clients with substantial memory and processing resources (e.g., TV-enabled personal computers, TV recorders equipped with hard-disks) to low-resource clients with limited memory and/or processing resources (e.g., traditional set-top boxes). While aspects of the systems and methods described below can be used in any of these systems and for any types of clients, they are particularly well in suited for systems with low-resource clients. Hence, the following discussion describes the systems and methods in the context of a low-resource environment.

Television Entertainment System

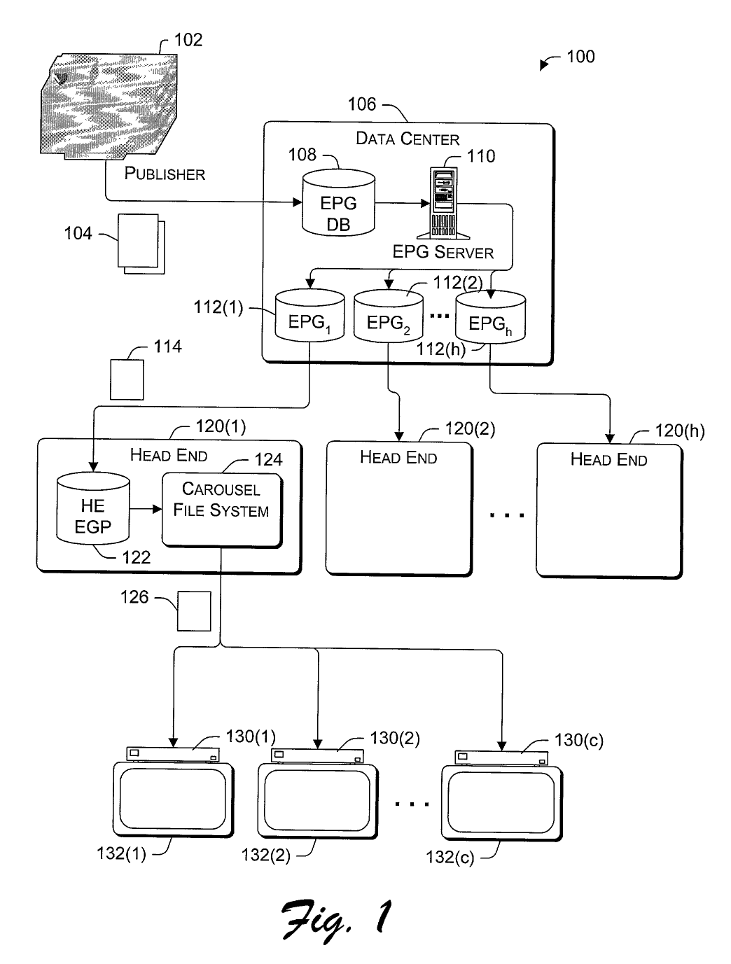

FIG. 1 shows a television entertainment system 100 that facilitates distribution of program data from a publisher to the viewers. System 100 includes a publisher 102 that creates the program data. One example of a publisher 102 is the Tribune Corporation, which generates data for interactive television networks. As used herein, program data refers to the type of data that might be used by an electronic program guide (EPG) and/or to facilitate interactive television functionality. Program data includes program titles, ratings, characters, description, actor names, year made, station call letters, time schedules, channel numbers, and so on. The terms “program data” and “EPG data” are used interchangeably throughout this disclosure.

The EPG data is transferred as an electronic file 104 from the publisher 102 to a data center 106. As one example, the program data 104 is transferred using a file transfer protocol (FTP) over a TCP/IP network (e.g., Internet, UNIX, etc.) to the data center 106. The electronic file 106 is stored in an EPG database 108 at the data center 106.

The original version of the EPG data contains all of the programming information for multiple days. An EPG server 110 resides at the data center 106 to process the EPG data prior to distribution. The processing involves one or more techniques to condition the EPG data so that a low resource client can handle the data more effectively. Low resource clients, such as a set top box, are typically characterized as having limited memory and/or processing resources. Such clients may not be able to store the entire original version of the EPG data. With limited resources at the client, the processes performed by the EPG server 110 are helpful to precondition the EPG data into a more suitable form for storage and processing at the client.

Among other processes, the EPG server 110 is configured to reduce the amount of EPG data so that it can be stored at low-resource clients. The EPG server 110 might also alter the format or structure of EPG data 104 to enable easier searching or other processes at the clients. The EPG server 110 might also compress the EPG data prior to its distribution.

The EPG server 110 creates different versions of the program data for different head end services to account for programming preferences and lineups. For example, the EPG server 110 limits the EPG data to those channels that are relevant to the respective head ends. In the illustrated example, the EPG server 110 creates multiple versions of the EPG data, which are designated as EPG₁, EPG₂, . . . , EPGₕ, and stores them in respective databases 112(1), 112(2), . . . , 112(h). The data center 106 transfers the head end versions of the EPG data as electronic files 114 to associated head end services 120(1), 120(2), . . . , 120(h) using, for example, FTP or other suitable transfer protocols over a network.

At individual head end services, as represented by service 120(1), the EPG data is stored in a head end database 122. A carousel file system 124 repeatedly broadcasts the EPG file 126 over an out-of-band (OOB) channel to the clients 130(1), 130(2), . . . , 130(c). The distributed EPG file 126 may or may not be identical to the file 114 received from the data center 106. Distribution from the head ends 120 to the clients 130 may be accommodated in a number of ways, including cable, RF, microwave, network (e.g., Internet), and satellite.

In the illustrated implementation, the clients 130 are embodied as set top boxes (STBs) connected to associated televisions 132(1), 130(2), . . . , 132(c). The clients 130 are often equipped with sufficient processing and storage capabilities to store and run an operating system and a few programs. Examples of programs stored on a client might include a Web browser, an electronic programming guide, a personal scheduler, and so forth. Although the STBs are shown separately from the television sets, they may alternatively be built into the television sets as integral units. Furthermore, in other implementations, the clients may be embodied as other devices capable of handling EPG data, such as a broadcast-enabled computer, an information appliance, or the like.

Exemplary EPG Server

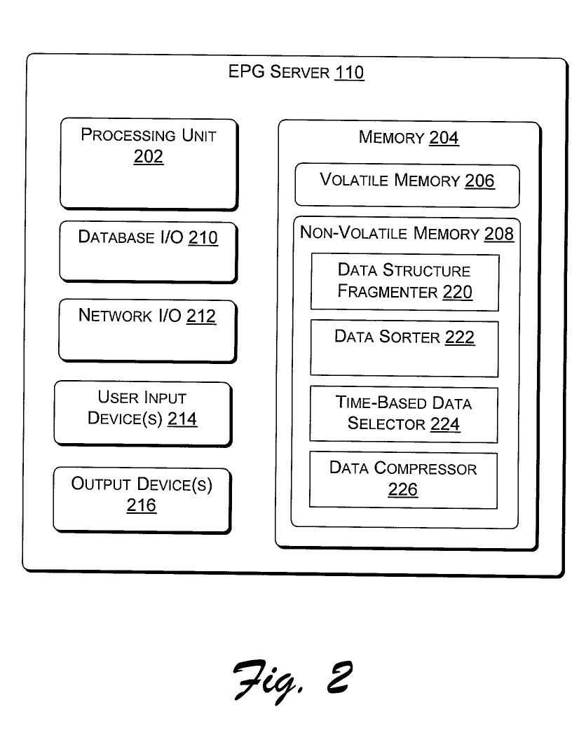

FIG. 2 shows an exemplary implementation of the EPG server 110. It has a processing unit 202 and memory 204. Memory 204 includes volatile memory 206 (e.g., RAM) and non-volatile memory 208 (e.g., ROM, flash, floppy disk, hard disk, CD-ROM, disk array, etc.). The server 110 may be further equipped with a database I/O 210 to interface with the EPG database 108 and/or version databases 112(1)-112(h) and a network I/O 212 to provide access to one or more networks. The server 110 may optionally be equipped with one or more input devices 214 (e.g., keyboard, mouse, track ball, touch panel screen, etc.) and one or more output devices 216 (e.g., display, printer, etc.).

One or more programs are stored in memory 204 and executed on processing unit 202 to process the EPG data. The programs include a data structure fragmenter 220, a program table constructor 222, a time-based data selector 224, and a data compressor 226. The EPG server 110 also runs an operating system (not shown), such as a Windows® brand operating system from Microsoft Corporation, or a Unix-based operating system.

The various processes performed by the EPG server 110 are intended to place the EPG data in better condition for handling by the low resource client. The data structure fragmenter 220 pre-formats the data at the server for use by the client. The client 130 has previously designated an arbitrary data set size for a particular application, such as an EPG application, and allocates a block of memory in segments of that size. The arbitrary size is communicated to the EPG server 110, and the data structure fragmenter 220 “fragments” the data in advance of delivery to the client 130. The client-designated arbitrary data size is thus guaranteed by the server 110 to be the size of data transmitted to the client. Therefore, when the client 130 receives the data, the client can allocate the data packets to the pre-allocated segments in memory without making system calls to the memory.

The data sorter 222 pre-sorts EPG data to improve searching at the client. The EPG data is pre-sorted according to a type of field, such as a title. The data sorter 222 constructs a table with the pre-sorted data and this table is used by the client to facilitate fast searches, even though the client has limited processing resources.

The time-based data selector 224 selects which program data to be included in the file to be downloaded to the client. Low resource clients may not be able to store and display program schedule information for multiple days because of limited memory. The time-based selector 224 selectively stores more data for a current time period represented by the EPG (e.g., the current day) and progressively less data over time for subsequent time units (e.g., next several days). This enables a rich display of information for the time period in which viewers are most likely interested, while offering some additional subset of data for future programming.

The data compressor 226 can be used to compress data destined for the client to a compressed format that remains easily searchable at the client. In one implementation, the data compressor 226 makes an initial pass through the data and constructs a table identifying the most frequently used character sequences. During a subsequent pass, the data compressor 226 compresses the data string by substituting a value for the most frequent character sequences. The data compressor 226 constructs a code table that tracks which values are substituted for the character sequences. The compressed data file and code table can then be downloaded to the client for decompression.

It is noted that the processes carried out by the EPG server are described as being implemented in software. However, in alternative implementations, some or all of these processes may be implemented in firmware and/or hardware.

Exemplary Client

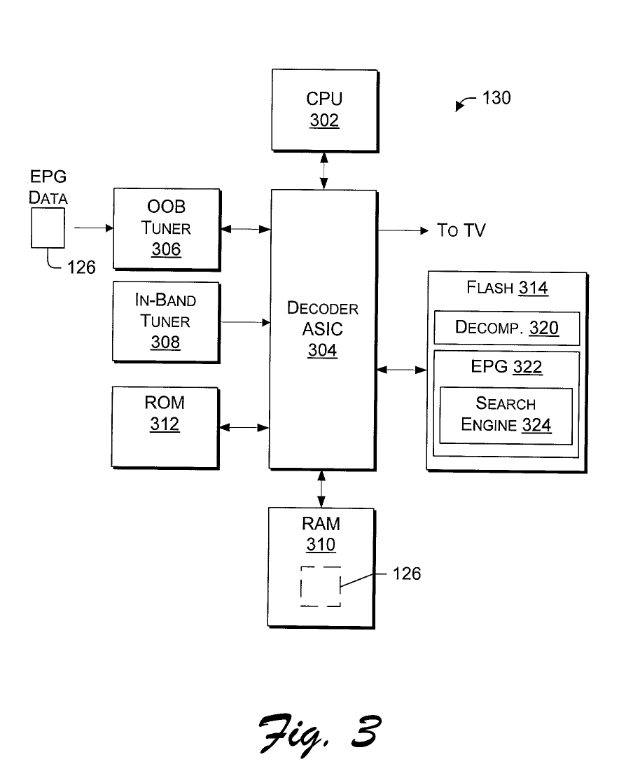

FIG. 3 shows an exemplary client 130 implemented as a set-top box. The client 130 has a central processing unit (CPU) 302 coupled to a decoder ASIC (application specific integrated circuit) 304. In addition to decoder circuitry, ASIC 304 may also contain logic circuitry, bussing circuitry, and a video controller. The client 130 further includes an out-of-band (OOB) tuner 306 to tune to the broadcast channel over which the EPG data file 126 is downloaded. One or more in-band tuner 308 is also provided to tune to various television signals. These signals are passed through the ASIC 304 for audio and video decoding and then to an output to the television set. With the tuners and ASIC 304, the client is equipped with hardware and/or software to receive and decode a broadcast video signal, such as an NTSC, PAL, SECAM or other TV system video signal and provide video data to the television set.

One or more memories are coupled to ASIC 304 to store software and data used to operate the client. In the illustrated implementation, the client has random access memory (RAM) 310, read only memory (ROM) 312, and flash memory 314. RAM 310 stores data used by the client, including the EPG data file 126 as well as any compression table used to decompress the file. ROM 312 stores an operating system (not shown).

One or more programs may be stored in the ROM 312 or in the flash memory 314. In the illustrated example, the flash memory 314 stores a decompression program 320 that can be executed to decompress the EPG data file 126. An EPG program 322 is also stored in the flash memory 314 to operate on the EPG data 126. The EPG program 322 may include a search engine 324 to search the EPG data in response to queries submitted by the viewer. The search engine might be used, for example, to locate particular television shows by title, or find shows with a particular rating, or identify programs with selected actors.

The client 130 may further include other components, which are not shown for simplicity purposes. For instance, the client is typically equipped with hardware and/or software to present a graphical user interface to a viewer, by which the viewer can navigate the EPG, or (if enabled) to access various Internet 11 system network services, browse the Web, or send email. Other possible components might include a network connection (e.g., modem, ISDN modem, etc.) to provide connection to a network, an IR interface, display, power resources, etc. A remote control may further be provided to allow the user to control the client.

Table Arrangement of Sorted EPG Data

Low resource client 130 has limited memory resources. For example, set top boxes are typically manufactured with a fixed amount of memory that satisfies the manufacturer's price/performance criteria. A portion of this memory is allocated to hold EPG data. The amount of EPG data to be transmitted down to the set top box might be expected to consume, for example, no more than 500K bytes of memory. Furthermore, once the EPG data is stored at the client 130, there is limited processing resources to perform operations on the data, such as searching.

Accordingly, one process performed on the EPG data prior to delivery to the client concerns structuring the EPG data in a way that facilitates searching at the client. The EPG data is pre-sorted at the EPG server 110 according to data type, such as by titles of programs. The pre-sorted EPG data is arranged in tables that are delivered and stored at the client. The pre-sorted tables are conducive to fast searches at the client, even though the client has limited processing capabilities. It is noted that the sorting process may be performed at other computing sites in system 100, including at the head end services 120.

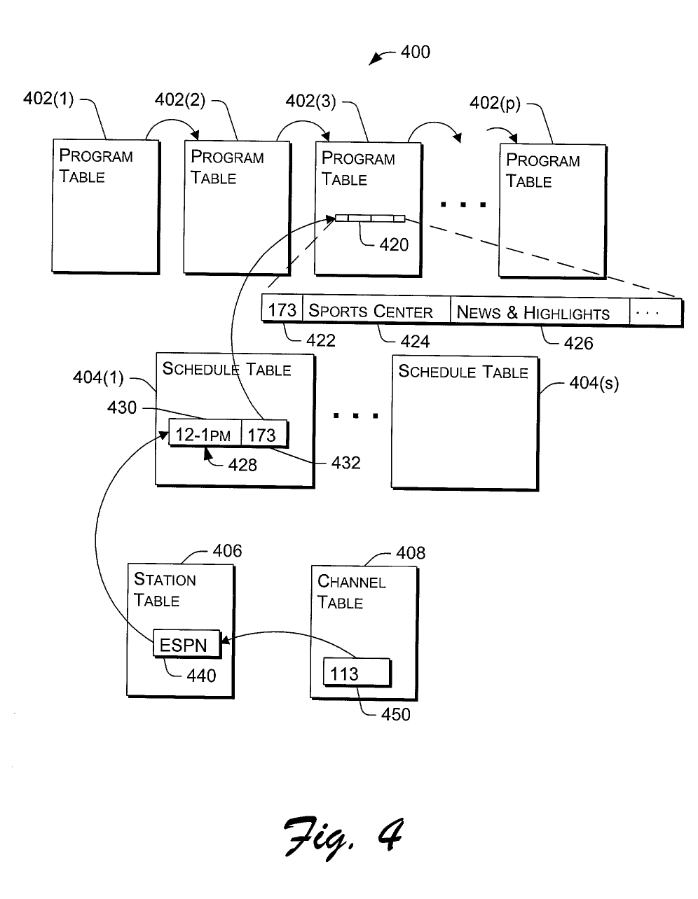

FIG. 4 shows exemplary EPG data 400 to be delivered to the client. The EPG data 400 is stored in multiple tables, where individual tables are employed to ii store similar data of a particular type. In the illustrated example, there are one or more program tables 402(1), 402(2), 402(3), . . . , 402(p) containing program listings, one or more schedule tables 404(1), . . . , 404(s) containing schedule-related data, a station table 406 containing station information, and a channel table 408 containing real/virtual channel and frequency information.

The tables store the program data in records. For example, the program tables 402 consist of records pertaining to programming information, as represented by program record 420. Each program record 420 has one or more fields, such as a program identifier field 422, a program title field 424, a program description field 426, and so on. The schedule table 404 has records pertaining to scheduling information, as represented by program record 428. Each schedule record 428 has one or more fields, such as a time field 430 and a program identifier field 432. The station table 406 has records pertaining to station information, as represented by station record 440. These station records 440 may include one or more fields used to identify a station, such as its call letters, a corporate entity description, and so on. The channel table 408 stores records pertaining to channel information, as represented by channel record 450. The channel records 450 may include one or more fields used to identify a channel, such as a channel identifier, a channel frequency, and so on.

The tables are related so that records in one table can cross-index into related information in one or more other tables. For instance, the channel record 450 in channel table 408 may index to a station record 440 in the station table to identify the call letters for the channel identifier. That station record 440 may then index into the schedule table 404 to identify multiple records 428 defining the schedule for that station. The schedule records 428 may further reference i individual program records 420 in the program tables 402. The program records 420 hold the details of the programs corresponding to the time slots identified in the schedule table 404 for the particular station or channel.

The tabular data structure 400 represents the native form of the EPG data that can be delivered, via broadcast or other means, to the clients. The EPG data can be indexed by channel to allow individual networks to obtain the appropriate EPG data for their clients. The EPG program at the client understands the native form and can process the data to perform various operations. In its unsorted state, however, the EPG data is not conducive to fast searches on the low resource client. The client is faced with either sorting the existing EPG data on its own, which is resource expensive, or performing lengthy searches on unsorted data, which is slow.

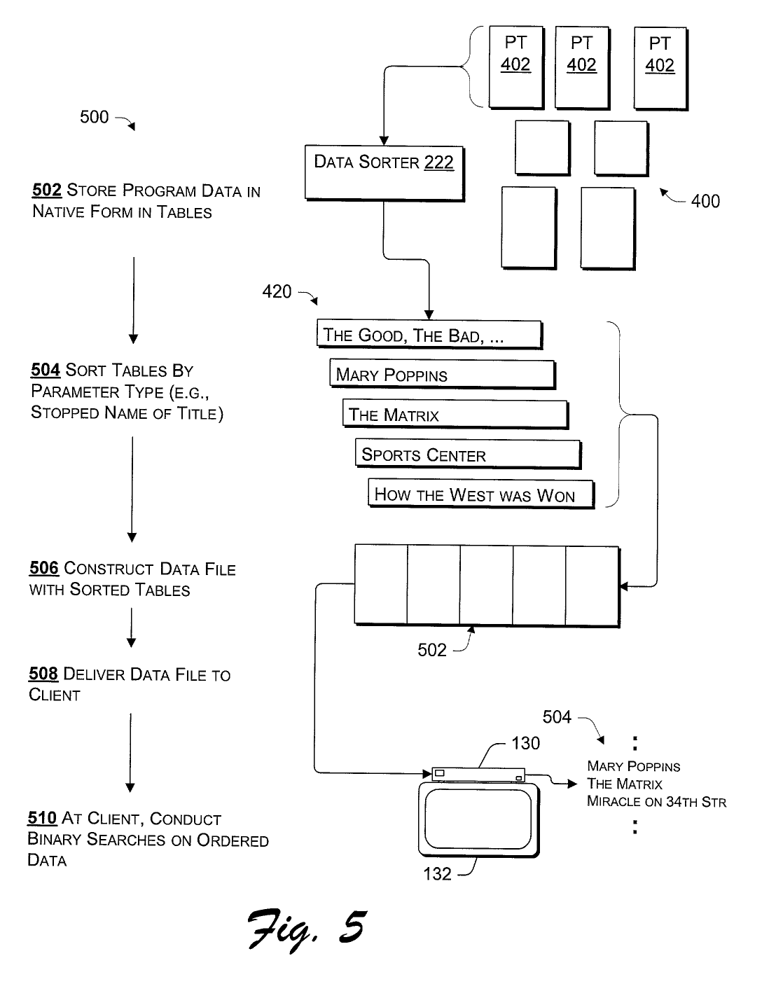

FIG. 5 illustrates one exemplary implementation of the sorting process 500 for sorting the EPG data 400. The process is described with reference to a diagrammatic illustration depicting exemplary components of the television entertainment system 100 that might be used to perform the enumerated operations.

At 502, the program data is stored in native form in multiple tables. This is represented by the tabular data structure 400 shown in FIG. 4, and diagrammatically illustrated in FIG. 5. The program listings are thus originally stored in program tables 402 in the order produced by the EPG data publisher 102.

At 504, the data sorter 222 at the EPG server 110 sorts the program data in the tables by a specific parameter type that a viewer is anticipated to want to search. For example, in one implementation, the data sorter 222 arranges EPG data in the program tables alphabetically according to the “stopped name” of the program. The “stopped name” of a program is the shortened version of the program title that contains the identifying words, without common joiner words such as “the”, “and”, etc. For example, the movie “The Good, The Bad, and The Ugly” might have a stopped name of “Good, Bad, Ugly” and the program “How the West was Won” might have a stopped name of “West Won”.

An example set of program records 420 for different programs is shown in FIG. 5. Notice that the program record for the movie “The Good, The Bad, and The Ugly” is ordered alphabetically under “G” rather than under “T”. Similarly, the movie “The Matrix” is arranged under “M” and the program “How the West was Won” is sorted under “W”.

If there is EPG data for multiple days, the data sorter 222 sorts the program records for each day independently of the other. This will produce multiple sets of sorted program data for corresponding multiple days. Alternatively, all of the records for all of the days can be sorted together. It is also noted that other servers besides the EPG server 110 may be employed to perform the sorting techniques as described herein, such as servers at head end services 120.

At 506, the EPG server 110 constructs a data file 502 for delivery to the client. The data file 502 holds the tables, including the sorted program tables. If there is EPG data for multiple days, one data structure is constructed for each day. The one or more data structures 502 may then be broken into multiple chunks that may or may not be the same size. Each chunk is atomic, containing a range of records and an index to describe where the records in the table(s) fit within the context of the whole EPG data file. Each chunk may hold parts of one table or up to multiple tables. Individual tables know in which chunk they reside. Table boundaries are therefore different than chunk boundaries, although they may coincide.

At 508, the data file 502 is delivered to the client 130 via the head end service. When the client 130 receives the data file, it stores the data file in RAM 310.

At 510, the client performs a search over the data structure stored in RAM. Due to the pre-sorted arrangement of the records, the client is able to perform a simple and fast binary search on the data. For instance, suppose viewer is 19 interested in locating the movie, “The Matrix”. The client's search engine 324 performs a binary search through the title fields of the program records, comparing two titles at a time. Here, the movie “The Matrix” is ordered after “Mary Poppins” and before “Miracle on 34^{th} Street” as represented by title listing 504.

Where data structures for multiple days exist, the search engine 324 performs a two-phase searching process. A first phase involves a binary search of the program data for each day to produce intermediate results. Suppose, for example, that the program data covers five days, Monday through Friday. The first phase produces search results for each data, Monday through Friday. A second phase combines the daily results produced from the first phase and sorts them. The final results are then returned.

Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. Method comprising:
storing program data for an electronic program guide in multiple tables, each table comprising one or more records with one or more fields; and
sorting the records in the tables according to a selected field type prior to delivery of the program data to a remote client.

2. A method as recited in claim 1, wherein the tables comprises a particular structure and the sorting rearranges the records without changing the particular structure.

3. A method as recited in claim 1, wherein the selected field type is selected from a group of fields including actor names, program genre, title, and ratings.

4. A method as recited in claim 1, wherein the records comprise program records containing programming information, individual program records having a title field to identify a program name, and the sorting comprises arranging the program records in the tables according to a stopped name version of the program name in the title field.

5. A method as recited in claim 1, further comprising constructing a data file to hold the sorted tables.

6. A method as recited in claim 5, further comprising delivering the data file to the remote client.

7. A method as recited in claim 5, wherein the storing, the sorting, and the constructing are repeated for each day of program data.

8. A method for delivering program data for an electronic program guide executing at a remote client, the method comprising:
storing program data for an electronic program guide in multiple tables, the tables comprising one or more program tables with records of programming information, the program tables having a title field for program titles;
sorting the records in the program tables according to the title field; and
constructing a data file to hold the tables.

9. A method as recited in claim 8, wherein the sorting comprises arranging the records according to stopped name versions of program names in the title field.

10. A method as recited in claim 8, further comprising delivering the data file to the remote client.

11. A method as recited in claim 10, further comprising searching, at the client, the program records using a binary search.

12. A method as recited in claim 8, wherein the storing, the sorting, and the constructing are repeated for each day of program data.

13. A method as recited in claim 12, further comprising:
delivering the data files to the remote client; and
searching, at the client, the program records in each of the data files for each day of program data to produce temporary results from each of the data files and subsequently searching the temporary results.

14. A computer-readable medium comprising computer-executable instructions that, when executed, direct a computing system to:
sort program data for an electronic program guide according to stopped names of program titles; and
store the program data in a data structure for delivery to a remote client.

15. A computer-readable medium as recited in claim 14, further comprising computer-executable instructions that, when executed, direct a computing system to deliver the data structure to the remote client.

16. A data structure stored on a computer-readable medium, comprising:
multiple tables to store program data for use in an electronic program guide;
the tables comprising program tables composed of records with programming information, the program tables having a title field to hold program titles; and
the records of the program tables being sorted by stopped name versions of the program titles.

17. A computer system, comprising:
a memory;
a processor coupled to the memory; and
a data sorter program stored in memory and executed on the processor to sort electronic program guide (EPG) data according to a data type prior to delivery of the EPG data to a remote client.

18. A computer system as recited in claim 17, wherein the data type is a program title, and the data sorter program is configured to sort the EPG data according to a stopped name version of the program title.

19. A computer system as recited in claim 17, wherein there is EPG data for multiple days, and the data sorter program is configured to sort the EPG data separately for each day.

20. A processing system, comprising:
sorting means for sorting program data for an electronic program guide according to a data type that a viewer is likely to search; and
transmission means for transmitting the sorted program data to the client.

21. A processing system as recited in claim 20, wherein the sorting means sorts the program data according to stopped names of program titles.

22. A television entertainment system, comprising:
multiple clients to receive television signals and corresponding program data for an electronic program guide (EPG), individual clients having a search engine to search the program data; and
an EPG server to sort the program data prior to delivery to the client, the program data being sorted according to a selected parameter to place the program data in a sorted arrangement to facilitate searching at the client.

23. A television entertainment system as recited in claim 22, wherein the EPG server sorts the program data according to program title.

24. A television entertainment system as recited in claim 22, wherein the EPG server sorts the program data according to stopped name versions of program titles.

25. A television entertainment system as recited in claim 22, wherein individual clients are configured to search the program data using a binary search engine.

26. A television entertainment system as recited in claim 22, wherein the program data covers multiple days, and the EPG server is configured to sort the program data for each day separately from other days, and individual clients are configured to perform a two-phase search in which a first phase involves a search of the program data for each day and a second phase involves a search of results produced from the first phase.
